(19) United States
(12) Patent Application Publication
(10) Pub. No.: US 2022/0032421 A1
(43) Pub. Date: Feb. 3, 2022

(54) Inflatable Tumbler Attachment

(71) Applicants: Melissa Weber, Junction City, KS (US); Michael Treichler, Junction City, KS (US)

(72) Inventors: Melissa Weber, Junction City, KS (US); Michael Treichler, Junction City, KS (US)

(21) Appl. No.: 17/379,326

(22) Filed: Jul. 19, 2021

Related U.S. Application Data
(60) Provisional application No. 63/058,054, filed on Jul. 29, 2020.

(51) Int. Cl. B24B 31/12

(52) U.S. Cl. CPC B24B 31/12

(57) ABSTRACT

This present invention relates to an inflatable tumbler spindle attachment device designed to accommodate tumbler drinking cups of different sizes and shapes while performing decorative processes such as epoxy coating, painting, and others. The inflatable tumbler spindle attachment device features one, two or three inflatable rings connected with two inflatable shafts that firmly holds the tumbler drinking cup on the tumbler spindle and prevents the tumbler cup from slipping off the tumbler spindle. The rings are inflated to grip the tumbler cup to the tumbler spindle, thereby enabling the user to apply various decorative materials to the exterior surface of the tumbler cup. The inflatable tumbler spindle attachment device saves time, effort and money while decorating tumbler cups.

### CROSS-REFERENCE TO RELATED APPLICATION

The present application claims priority to, and the benefit of, U.S. Provisional Application No. 63/058,054, which was filed on Jul. 29, 2020 and is incorporated herein by reference in its entirety.

### FIELD OF THE INVENTION

The present invention relates generally to the field of work holding tools that are commonly used on tumbler cup rotator machines. More specifically, the present invention relates to an inflatable work holding device that allows the user to securely hold a variety of different tumblers (or drinking cups) with a single standard-sized tumbler spindle. The inflatable work holding device includes one, two or three inflatable rings that are interconnected to two inflatable shafts, which firmly attach the workpiece to the tumbler spindle. The device eliminates the need to locate a tumbler spindle to fit all different sizes and types of tumblers or cups, and ensures that the epoxy, paint or glitter can be applied to the exterior surface of the tumbler while being held firmly in place on the tumbler spindle. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, machining tools such as lathes have been used throughout history for turning various workpieces made from metal, wood, or plastic. In general, a workpiece is attached to a rotatable spindle by one or more work holding attachments so that when the spindle and workpiece rotate, a cutting tool can move along the workpiece and thereby remove material from the workpiece to achieve the desired shape and size. Sometimes, it is desirable to hold a hollow workpiece by its inside surface using a work holding attachment such as a mechanized expandable mandrel so that the lathe cutting tool can remove material for the outside surface of the workpiece.

Nowadays, another machine that is commonly known in the art as a tumbler cup rotator machine shares many of the same operational functions as that of a lathe. Specifically, a tumbler cup rotator machine is designed to hold and rotate tumblers or other types of drinking cups so that the exterior surface of the tumbler can be decorated with epoxy, paint, glitter or other decorative finishes. The tumbler cup rotator machine includes a motor for controlling the rotation of a tumbler spindle. Currently, the user has to match the proper size and shape of the tumbler spindle to the workpiece, which is a tumbler or other drinking cup. Additional inserts may be placed between the tumbler spindle exterior surface and the interior surface of the tumbler drinking cup to fill the gaps between the two surfaces. Instead of removing material like a traditional tumbler cup rotator machine, the tumbler cup rotator machine of the present invention allows the user to place epoxy, paint, or glitter at specific locations on the tumbler while it is slowly rotated on the tumbler spindle.

Current tumbler cup rotator machines require the user to select a conventional tumbler spindle as a work holding attachment for the tumbler drinking cup. Sometimes this requires a custom sized and shaped tumbler spindle. Next, inserts may be placed between the tumbler spindle exterior surface and the interior surface of the tumbler drinking cup to fill the gaps between the two surfaces. Even then, the tumbler drinking cup can still fall off or slide on the tumbler spindle, thus causing the user to start the decoration process over again. If this occurs, the tumbler has to be re-cleaned, re-mounted to the spindle, and the decoration process is started over, which takes more time for the finishing of the tumbler, and wastes expensive decorative materials. This makes the complete process difficult and inconvenient for users. Further, restarting the process repeatedly may also result in the loss of material, which eventually causes loss of money to users making the task more expensive and frustrating.

Additionally, users may face different issues while using the conventional tumbler cup rotator machine. As an example, while using the conventional tumbler spindle for holding a tumbler drinking cup, the open-end of the tumbler can be designed to have a smaller diameter as compared to the remaining interior portion of the tumbler. In such a case, the tumbler spindle will not fit into the tumbler. Further, an incorrect fit-up between the tumbler spindle and the interior surface of the tumbler drinking cup can result in the tumbler cup becoming loose, and thereby moving while it is drying, causing uneven layers of epoxy, resins or other materials.

Furthermore, for a perfect fitting of different sized tumblers to the tumbler spindle, different types of tumbler inserts are required, so that the tumblers can be turned without falling off, and other finishing operations may be properly performed on the tumblers. However, none of the current turning devices accommodate different sizes and types of tumblers. This causes inconvenience to the user since several different tumbler spindles and inserts are necessary, which eventually adds to unnecessary costs the budget of the user.

Therefore, there exists a long felt need in the art for an inflatable tumbler cup rotator machine attachment device that prevents a tumbler drinking cup from falling off the tumbler spindle while the user is performing various finishing and decorating operations on the tumbler drinking cup. There is also a long felt need in the art for an inflatable tumbler spindle attachment device that can securely hold a tumbler cup in place, thereby preventing it from falling off or sliding on the tumbler spindle which would require the user to re-start the complete decorative process. Additionally, there is a long felt need in the art for an inflatable tumbler spindle attachment device that prevents the loss of both time and money associated with incomplete or damaged tumbler workpieces, and that is capable of properly fitting tumblers of various shapes and sizes. Furthermore, there is a long felt need in the art for an inflatable tumbler spindle attachment device that eliminates the need to locate, purchase and store multiple different turning tools or tumbler inserts to accommodate tumbler drink cups of different sizes and styles. Finally, there is a long felt need in the art for an inflatable tumbler spindle attachment device that is relatively inexpensive to manufacture and that is both safe and easy to use.

The subject matter disclosed and claimed herein, in one embodiment thereof, comprises an inflatable tumbler spindle attachment designed to inflate and firmly secure a tumbler drinking cup to a tumbler spindle. The attachment device comprises a plurality of inflatable rings of equal diameters that are interconnected to each other by two inflatable shafts, with each of said shafts attaching to two or more of said rings, thereby forming a continuous internal passage for air. Nonetheless, the plurality of inflatable rings do not have to have equal diameters and some may be smaller or larger than others. The said rings form a central opening to place the present invention inflatable tumbler spindle attachment device onto a tumbler spindle wherein a tumbler drinking cup is then placed over the novel inflatable tumbler spindle attachment device, and is further held in place on the tumbler spindle once the device has been properly inflated.

In this manner, the novel inflatable tumbler spindle attachment device of the present invention accomplishes all of the forgoing objectives, and provides a relatively easy, convenient, efficient and cost-effective solution for holding a tumbler drinking cup to a tumbler cup rotator machine for adding various decorative features to the exterior surface of the tumbler cup. The inflatable tumbler spindle attachment device of the present invention is also user friendly, as the novel tumbler spindle attachment device ensures that epoxy, paint and glitter can be easily applied to the tumbler cup exterior without allowing it to fall off or slide on the tumbler spindle, which would require the user to start the complete decorative process over again. This saves time, effort, and money for users. Additionally, the inflatable tumbler spindle attachment device can accommodate tumbler drinking cups of different sizes and styles, thereby eliminating the need to buy different sized tumbler spindles. The inflatable tumbler spindle attachment device makes the tumbler cup decorative process more convenient and economical for the user.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inflatable tumbler spindle attachment device designed to inflate and firmly secure tumblers or cups of various sizes for applying epoxy, paint, glitter and other decorative materials to the exterior surface of a tumbler cup. The device comprises a plurality of inflatable rings of equal diameters that are interconnected to each other by two inflatable shafts, wherein each shaft is attached to two or more said rings, thereby forming a continuous internal passage for air. The said rings form a central opening to place the present invention inflatable tumbler spindle attachment device onto a tumbler spindle, wherein a tumbler drinking cup is then placed over the novel inflatable tumbler spindle attachment device.

In a further embodiment of the present invention, a unique inflatable tumbler spindle attachment device for securely holding tumblers or cups of various sizes on a tumbler cup rotator machine is disclosed and comprised of three interconnected inflatable rings, two or more inflatable shafts interconnecting the three rings, and a means to receive pressurized air from an air pump to inflate the rings and the shafts to increase the diameter of the rings to securely hold a tumbler cup onto a tumbler spindle. The rings form a central opening to place the unique inflatable tumbler spindle attachment device onto a tumbler spindle that is typically made from PVC pipe, which is part of a tumbler cup rotator machine.

In yet another embodiment of the present invention, a method of using the novel inflatable tumbler spindle attachment device for securely holding a tumbler or cup on a tumbler cup rotator machine is disclosed. The attachment device comprises the steps of sliding the central ring portions of the novel attachment device onto a tumbler spindle, wherein the central ring portion is formed by three inflatable rings, placing a tumbler cup onto the tumbler spindle and over the inflatable rings, inflating the novel attachment device with an air pump, starting/stopping the rotation of the tumbler spindle, and applying epoxy, paint, glitter and other decorative materials on the exterior surface of the tumbler cup.

In a further embodiment of the present invention, a unique inflatable tumbler spindle attachment device for securely holding a tumbler or cup on a tumbler cup rotator machine is disclosed. The attachment device comprises two interconnected inflatable rings, two inflatable shafts interconnecting the two rings, and an air-receiving hole or opening to receive pressurized air from an air pump to inflate the rings and the shafts, which will increase the diameter of the rings to securely hold a tumbler on the tumbler spindle. The rings form a central opening to place the unique inflatable tumbler spindle attachment device onto a tumbler spindle for rotation.

The unique inflatable tumbler spindle attachment device of the present invention is particularly advantageous because it prevents the tumbler from falling off while performing decorating operations on the tumbler. Further, it eliminates having to repeat the finishing/decorating process due to inadvertent slipping and moving of the tumbler, which is a common occurrence when using conventional inserts between a tumbler spindle and a tumbler thereby making the process easy and convenient for the user. The inflatable tumbler spindle attachment device properly fits tumblers of varying sizes and shapes, and eliminates the need to locate and buy multiple tumbler spindles to accommodate tumblers of different sizes and styles.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the inflatable tumbler spindle attachment device of the present invention in accordance with the disclosed architecture;

FIG. 2 illustrates a perspective view of one potential embodiment of the inflatable tumbler spindle attachment device of the present invention about to be attached to a tumbler cup rotator machine in accordance with the disclosed architecture;

FIG. 3 illustrates a perspective view of one potential embodiment of the inflatable tumbler spindle attachment device of the present invention fully attached to a tumbler cup rotator machine in accordance with the disclosed architecture;

FIG. 4 illustrates a perspective view of one potential embodiment of the inflatable tumbler spindle attachment device of the present invention attached to a tumbler cup rotator machine in accordance with the disclosed architecture, wherein a cutaway view of a tumbler is presented to show the tumbler installed on the inflatable tumbler spindle attachment device;

FIG. 5 illustrates a perspective view of one potential embodiment of the inflatable tumbler spindle attachment device of the present invention attached to a tumbler cup rotator machine in accordance with the disclosed architecture, wherein a tumbler is installed on the inflatable tumbler spindle attachment device and the device is being inflated with compressed air; and

FIG. 6 illustrates a perspective view of one potential embodiment of the inflatable tumbler spindle attachment device of the present invention attached to a tumbler cup rotator machine in accordance with the disclosed architecture, wherein a user is handling a tumbler installed on the inflatable tumbler spindle attachment device.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an inflatable tumbler cup rotator machine attachment device that prevents a tumbler drinking cup installed thereon from falling off the tumbler spindle while the user is performing various finishing and decorating operations on the tumbler cup. There is also a long felt need in the art for an inflatable tumbler spindle attachment device that can securely hold a tumbler cup in place, thereby preventing it from falling off or sliding on the tumbler spindle, which would require the user to start the complete decorative process over again. Additionally, there is a long felt need in the art for an inflatable tumbler spindle attachment device that makes the tumbler decorating process easier and less time-consuming for users, and that prevents the loss of revenue typically associated with incomplete and/or damaged tumblers. Furthermore, there is a long felt need in the art for an inflatable tumbler spindle attachment device that is capable of supporting tumblers of varying sizes and shapes, and that eliminates the need to locate and buy multiple turning tools or tumbler inserts to accommodate tumbler drink cups of different sizes and styles. Finally, there is a long felt need in the art for a tumbler spindle attachment device that is relatively inexpensive to manufacture and that is both safe and easy to use.

The present invention, in one exemplary embodiment, comprises an inflatable tumbler spindle attachment designed to inflate and firmly secure a tumbler drinking cup to a tumbler spindle comprises a plurality of inflatable rings of equal diameters that are interconnected to each other by two inflatable shafts, each said shaft is attaching to two or more said rings forming a continuous internal passage for air. The said rings form a central opening to place the present invention inflatable tumbler spindle attachment device onto a tumbler spindle wherein a tumbler drinking cup is then placed over the novel inflatable tumbler spindle attachment device, and is further held in place on the tumbler spindle once the device has been properly inflated.

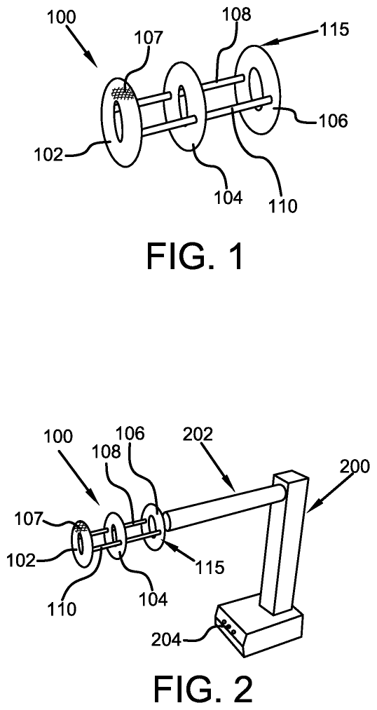

Referring initially to the drawings, FIG. 1 illustrates a perspective view of one potential embodiment of the inflatable tumbler spindle attachment device 100 of the present invention in accordance with the disclosed architecture. The inflatable tumbler spindle attachment device 100 is designed to inflate after it is slid onto a tumbler spindle 202 of a conventional tumbler cup rotator machine 200, as best shown in FIG. 2. The inflatable tumbler spindle attachment device 100 is comprised of three inflatable rings 102, 104, 106 of approximately equal diameters that are interconnected via two inflatable shafts 108, 110, thereby forming a generally circular opening within the center. The inflatable rings 102, 104, 106 and the shafts 108, 110 are sized in accordance with the tumbler spindle 202 of a conventional tumbler cup rotator machine 200. The inflatable nature of the inflatable tumbler spindle attachment device 100 allows a user to utilize a variety of tumbler cup 402 sizes with a single tumbler spindle 202.

The inflatable tumbler spindle attachment device 100 is designed to ensure that the epoxy, paint, glitter or other decorative materials dry evenly and without pooling or excess dripping. The novel inflatable tumbler spindle attachment device 100 works with tumblers, cups and wine glasses of different types and sizes. The inflatable tumbler spindle attachment device 100 has ample space to allow the user to hold a tumbler cup 402 placed over the tumbler spindle 202 by hand.

The inflatable tumbler spindle attachment device 100 of the present invention can come in different sizes and materials, and preferably has a rugged construction. The inflatable tumbler spindle attachment device 100 is very easy to install and remove from the tumbler spindle 202. The inflatable tumbler spindle attachment device 100 can be comprised of metal, rubber, plastic or any other suitable material or combination of materials that will permit expansion when the device 100 is inflated, as described more fully below. It may also be desirable to use a material or coating that minimizes slippage between the device 100 and the tumbler cup 402 positioned thereon when the device 100 is in use. It should also be appreciated that the inflatable tumbler spindle attachment device 100 is preferably a single-piece integrated unit with all of the rings 102, 104, 106 and shafts 108, 110 interconnected and in fluid communication with one another.

In another potential embodiment of the present invention, the inflatable tumbler spindle attachment device 100 may have only a single ring, or alternatively can have two rings. The variation in the number of rings and shafts is designed to support tumblers of different sizes and to fit different tumbler cup rotator machines 200.

The rings 102, 104, 106 of the inflatable tumbler spindle attachment device 100 are inflatable using a manual or an automatic air pump. The air pump can be activated by a user and may include a pressure regulator and a pressure gauge for selection of the proper air pressure when inflating the novel device 100. The conventional air pump can either be purchased separately or included with the inflatable tumbler spindle attachment device 100 of the present invention at the point of purchase, for example, as a kit. The air pump can be connected to the inlet 115 by a conventionally available and sized tubing 404 as best shown in FIG. 4, such that the compressed or pressurized air will pass through the inflatable shafts 108, 110 to inflate all of the rings 102, 104, 106 uniformly and consistently. Inlet 115 may also include an internal valve, similar to that of a conventional tire stem, for permitting removal of the tubing 404 after achieving the desired air pressure within the device 100. This will allow free rotation of the tumbler spindle 202 without restriction from the tubing 404. In this case, the internal air pressure can be reduced by depressing the internal valve on the inlet 115 for the removal of the tumbler cup 402.

FIG. 2 illustrates a perspective view of one potential embodiment of the inflatable tumbler spindle attachment device 100 of the present invention about to be attached to a tumbler cup rotator machine 200 in accordance with the disclosed architecture. As shown, the tumbler spindle 202 of the tumbler cup rotator machine 200 receives the inflatable tumbler spindle attachment device 100 through the central open portion, with which the device 100 is placed onto the tumbler spindle 202. Based on the size of the tumbler spindle 202, the central portion of the novel inflatable tumbler spindle attachment device 100 can be designed. Also, according to the size of the tumbler cup 402, the number of rings 102, 104, 106 can be increased or decreased. The inflatable tumbler spindle attachment device 100 prevents slippage of the tumbler cup 402 even when the tumbler spindle 202 is rotating. Accordingly, the other surface of rings 102, 104, 106 may have a non-slip finish or coating 107 thereon. The coating 107 may also contain an anti-microbial agent, such as Microban®.

The tumbler cup rotator machine 200 is preferably made up of a metal, plastic or other durable material, such that it can provide a sturdy frame for sustainable and repeated use. The tumbler cup rotator machine 200 can be operated using one or more control buttons 204, which can control the speed and rotational direction of the tumbler spindle 202. More specifically, the tumbler cup rotator machine 200 includes a motor (not shown) that is connected to the tumbler spindle 202 to provide rotation of the tumbler spindle 202, inflatable tumbler spindle attachment device 100 and the tumbler cup 402. The tumbler spindle 202 can be rotated in varying speeds and directions as per the desires and requirements of the user.

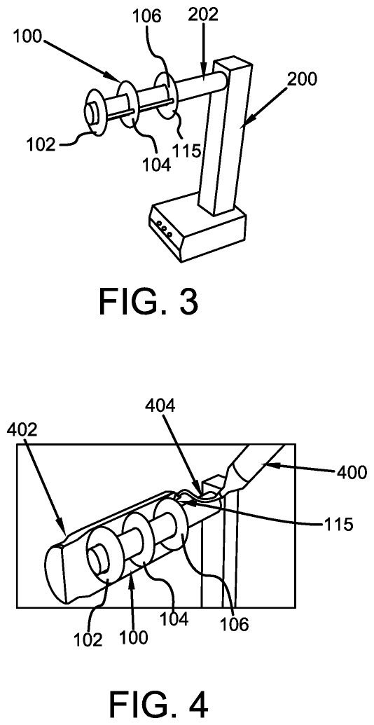

FIG. 3 illustrates a perspective view of one potential embodiment of the inflatable tumbler spindle attachment device 100 of the present invention fully attached to a tumbler cup rotator machine 200 in accordance with the disclosed architecture. As shown, the inflatable tumbler spindle attachment device 100 is placed fully onto the tumbler spindle 202 with the inflatable rings 102, 104, 106 placed around the spindle 202. More specifically, the inflatable rings 102, 104, 106 circumscribe the tumbler spindle 202. It should be noted that the tumbler spindle 202 is cylindrical in shape such that the diameter of the tumbler spindle 202 is approximately the same as the diameter of the central portion of the device 100. When placed on the tumbler spindle 202, the inflatable tumbler spindle attachment device 100 inflates, wherein the rings 102, 104, 106 expand radially in an outward direction, thus filling the gap between the tumbler spindle 202 and the tumbler cup 402. As stated earlier, the number of rings can be one or more in the inflatable tumbler spindle attachment device 100.

FIG. 4 illustrates a perspective view of one potential embodiment of the inflatable tumbler spindle attachment device 100 of the present invention attached to a tumbler cup rotator machine 200 in accordance with the disclosed architecture, wherein a cutaway view of a tumbler cup 402 is presented to show the tumbler cup 402 installed on the inflatable tumbler spindle attachment device 100. As shown, a tumbler drinking cup 402 of an appropriate size is placed over the inflatable tumbler spindle attachment device 100 prior to the inflation of rings 102, 104, 106 by a conventional air pump 400 that is attached to the novel device 100 at inlet 115 by tubing 404. The user 600 then selects the desired air pressure to securely hold tumbler cup 402 on the tumbler spindle 202. The non-slip nature of the inflatable tumbler spindle attachment device 100 enables the tumbler cup 402 to be rotated easily without any relative movement between itself and the tumbler spindle 202 thereby allowing the user to complete the decorative process to the tumbler cup 402 without having to be concerned about the tumbler cup 402 inadvertently slipping or falling off of the tumbler spindle 202.

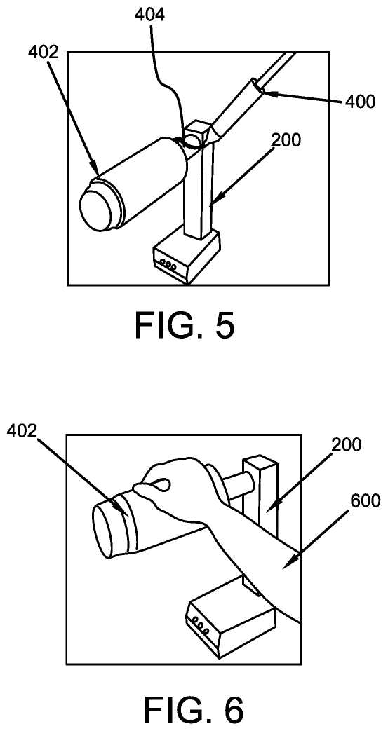

FIG. 5 illustrates a perspective view of one potential embodiment of the inflatable tumbler spindle attachment device 100 of the present invention attached to a tumbler cup rotator machine 200 in accordance with the disclosed architecture, wherein a tumbler 402 is installed on the inflatable tumbler spindle attachment device and the device 100 is being inflated with compressed air. As shown, a tumbler cup rotator machine 200 is operating the tumbler spindle 202 with the help of a built-in motor while the inflatable tumbler spindle attachment device 100 is placed onto the tumbler spindle 202 and a tumbler 402 is placed over the novel device 100. The advantage of the inflatable tumbler spindle attachment device 100 is that the rings are inflatable so that the tumbler cup 402 is held firmly in place on the tumbler spindle 202, regardless of its size.

The inflatable tumbler spindle attachment device 100 is inflated using an air pump 400 and the connected tubing 404. The rings 102, 104, 106 of the inflatable tumbler spindle attachment device 100 can be deflated easily as well after use, bringing the rings back to their original diameters. Once the tumbler cup 402 is placed on the tumbler spindle 202, the novel device 100 is inflated to grip the tumbler cup 402 securely. The decorative process to the tumbler cup 402 can now take place without the user having to be concerned about the tumbler cup 402 inadvertently slipping or falling off of the tumbler spindle 202.

FIG. 6 illustrates a perspective view of one potential embodiment of the inflatable tumbler spindle attachment device 100 of the present invention attached to a tumbler cup rotator machine 200 in accordance with the disclosed architecture, wherein a user 600 is handling a tumbler cup 402 installed on the inflatable tumbler spindle attachment device 100. As stated earlier, a user 600 can easily design and perform activity on the tumbler cup 402 while the tumbler cup rotator machine 200 is rotating the tumbler spindle 202, the novel device 100 and the tumbler cup 402. The conventional tumbler cup rotator machine 200 can be operated at the correct speed for curing/drying epoxy resin, paints, glitter and other decorative materials. In addition to tumbler drinking cups 402, ceramic mugs of various sizes ranging from 10-40 oz can also be used on the novel inflatable tumbler spindle attachment device 100 of the present invention.

The novel inflatable tumbler spindle attachment device 100 may further comprise logos, indicia, trademarks, geometric patterns, customizable colors and fonts, embroidery and prints and/or images on its surface. The novel inflatable tumbler spindle attachment device 100 may be commercially available as a standalone product which can come in various sizes, or may come with a tumbler cup rotator machine 200 in a package.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “inflatable tumbler spindle attachment device”, “inflatable tumbler spindle attachment”, and “novel device” are interchangeable and refer to the inflatable tumbler spindle attachment device 100 of the present invention.

Notwithstanding the forgoing, the inflatable tumbler spindle attachment device 100 of the present invention can be of any suitable size and configuration as is known in the art without affecting the overall concept of the invention, provided that it accomplishes the above stated objectives. One of ordinary skill in the art will appreciate that the size, configuration and material of the inflatable tumbler spindle attachment device 100 as shown in the FIGS. are for illustrative purposes only, and that many other sizes and shapes of the inflatable tumbler spindle attachment device 100 are well within the scope of the present disclosure. Although the dimensions of the inflatable tumbler spindle attachment device 100 are important design parameters for user convenience, the inflatable tumbler spindle attachment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tumbler handling device for attachment to a rotating tumbler machine having a spindle, the tumbler handling device comprising:
at least one inflatable ring; and
an air inlet.

2. The tumbler handling device as recited in claim 1 further comprising at least two inflatable rings.

3. The tumbler handling device as recited in claim 1 further comprising at least three inflatable rings.

4. The tumbler handling device as recited in claim 3 further comprising at least two inflatable shafts.

5. The tumbler handling device as recited in claim 4, wherein each of the at least two inflatable shafts are positioned between two of the at least three inflatable rings.

6. The tumbler handling device as recited in claim 5, wherein each of the at least two inflatable shafts are in fluid communication with the at least three inflatable rings.

7. The tumbler handling device as recited in claim 6, wherein each of the at least two inflatable shafts and each of the at least three inflatable rings are in fluid communication with the air inlet.

8. The tumbler handling device as recited in claim 7, wherein each of the at least three inflatable rings have the same diameter.

9. The tumbler handling device as recited in claim 7, wherein at least one of the at least three inflatable rings has a diameter that differs from a second one of the at least three inflatable rings.

10. The tumbler handling device as recited in claim 8, wherein at least one of the at least three inflatable rings has a non-slip exterior surface.

11. The tumbler handling device as recited in claim 8, wherein each of the at least three inflatable rings has a non-slip exterior surface.

12. The tumbler handling device as recited in claim 11, wherein each of the at least three inflatable rings has an anti-microbial coating.

13. A rotating tumbler system comprising:
a rotating tumbler machine comprised of a motor and a rotating spindle;
at least one inflatable ring positioned along the rotating spindle; and
an air inlet for inflating the at least one inflatable ring.

14. The rotating tumbler system as recited in claim 13 further comprising a source of compressed air.

15. The rotating tumbler system as recited in claim 14 further comprising at least three inflatable rings.

16. The rotating tumbler system as recited in claim 15 further comprising at least two inflatable shafts.

17. The rotating tumbler system as recited in claim 16, wherein each of the at least two inflatable shafts are positioned between two of the at least three inflatable rings.

18. The rotating tumbler system as recited in claim 17, wherein each of the at least two inflatable shafts are in fluid communication with each of the at least three inflatable rings and the air inlet.

19. The rotating tumbler system as recited in claim 18, wherein each of the at least three inflatable rings have the same diameter and a non-slip exterior surface.

20. A tumbler handling device for attachment to a rotating tumbler machine having a spindle, the tumbler handling device comprising:
a first inflatable ring;
a second inflatable ring;
a first inflatable shaft positioned between the first and second inflatable rings;
a third inflatable ring;
a second inflatable shaft positioned between the second and third inflatable rings; and
an air inlet in fluid communication with each of the first, second and third inflatable rings and each of the first and second inflatable shafts, wherein each of the first, second and third inflatable rings have a commonly sized diameter and is comprised of an anti-slip exterior surface.
